(19) United States
(12) Patent Application Publication
(10) Pub. No.: US 2010/0000301 A1
(43) Pub. Date: Jan. 7, 2010

(54) LIQUID CHROMATOGRAPH

(76) Inventor: Yosuke Iwata, Kyoto (JP)

Correspondence Address: Cheng Law Group, PLLC, 1100 17th Street, N.W., Suite 503, Washington, DC, 20036, US

(21) Appl. No.: 12/492,054

(22) Filed: Jun. 25, 2009

(30) Foreign Application Priority Data
Jul. 1, 2008 (JP) 2008-172366

(51) Int. Cl. G01N 30/04

(52) U.S. Cl. 73/61.55

(57) ABSTRACT

Disclosed herein is a liquid chromatograph in which a fractionation flow path, a non-fractionation flow path, a concentration flow path, and a secondary analysis flow path can be provided by operating flow path switching valves and flow path selecting valves. The concentration flow path and either one of the fractionation flow path and the non-fractionation flow path can be provided at the same time, and the secondary analysis flow path and either one of the fractionation flow path and the non-fractiontation flow path can also be provided at the same time.

### BACKGROUND OF THE INVENTION

1. Field of the Invention

The present invention relates to a liquid chromatograph such as a high-performance liquid chromatograph. More particularly, the present invention relates to a liquid chromatograph having the capability of trapping separated sample components in a concentrating column to concentrate the sample components.

2. Description of the Related Art

A conventional two-dimensional liquid chromatograph has the capability of trapping separated sample components in a concentrating column to concentrate the sample components (see, for example, Japanese Patent No. 3868899). When a sample is injected into an analysis flow path of such a two-dimensional liquid chromatograph, the sample is carried by a mobile phase and first introduced into a primary analytical column to separate it into components. Next, an eluate eluted from the primary analytical column is divided into fractions each containing at least one component to be analyzed, and each of the fractions is temporarily held in a sample holder such as a sample loop. In a case where two or more sample loops are provided, different components to be analyzed are held in different sample loops. Then, at least one component to be analyzed temporarily held in the sample loop is transported to a concentrating column for concentration, and the concentrated component(s) to be analyzed is (are) further transported from the concentrating column to a secondary analytical column for reanalysis.

However, such a conventional two-dimensional liquid chromatograph is not designed to simultaneously perform the operation of holding and fractionating components to be analyzed separated by primary analysis using one or more sample loops and the operation of introducing each of the fractionated components to be analyzed into a concentrating column for concentration. Therefore, in the case of using a conventional two-dimensional liquid chromatograph having only one sample loop, when one component to be analyzed is held in the sample loop, primary analysis is stopped until the concentration and secondary analysis of the component to be analyzed are completed. In the case of using a conventional two-dimensional liquid chromatograph having two or more sample loops, two or more components to be analyzed separated by primary analysis are fractionated using the sample loops, and then the fractionated components to be analyzed are sequentially introduced one by one into a concentrating column for concentration and subjected to secondary analysis.

According to the above description, if the operation of fractionating components to be analyzed and the operation of introducing each of the fractionated components to be analyzed into a concentrating column for concentration can be simultaneously performed, it is not necessary to stop the fractionating operation during the concentrating operation of the components to be analyzed, thereby reducing analysis time.

### SUMMARY OF THE INVENTION

It is therefore an object of the present invention to provide a liquid chromatograph capable of simultaneously performing the operation of fractionating components to be analyzed and the operation of introducing each of the fractionated components to be analyzed into a concentrating column for concentration.

The liquid chromatograph according to the present invention includes a liquid chromatograph including: a primary analysis flow path having a primary mobile phase sending system for sending a primary mobile phase, a primary analytical column for separating a sample carried by the primary mobile phase into component(s) to be analyzed, and a primary detector for detecting each of the components to be analyzed separated by the primary analytical column; at least two sample holders each provided downstream from the primary analysis flow path to hold an eluate containing at least one of the components to be analyzed separated by the primary analytical column; a concentration flow path having a concentration liquid sending unit for sending a liquid for concentration for use in transporting the eluate held in each of the sample holders and a concentrating column for trapping the component(s) to be analyzed contained in the eluate transported by the liquid for concentration; a secondary analysis flow path having a secondary mobile phase sending unit for sending a secondary mobile phase for use in eluting and transporting the component(s) to be analyzed trapped in the concentrating column, a secondary analytical column for further separating the component(s) to be analyzed transported by the secondary mobile phase, and a secondary detector provided downstream from the secondary analytical column; a first switching system for switching the connections of the sample holders to connect either or any one of the sample holders to the primary analysis flow path and to connect, between the concentration liquid sending unit and the concentrating column provided in the concentration flow path, another sample holder or one of the other sample holders not connected to the primary analysis flow path; and a second switching system for switching the connection of the concentrating column to connect the concentrating column either between the secondary mobile phase sending unit and the secondary analytical column provided in the secondary analysis flow path or to the concentration flow path.

In the liquid chromatograph according to the present invention, it is preferred that the number of the sample holders is three or more and that the first switching system is configured to connect each of the sample holders to the primary analysis flow path at different timing. This makes it possible, when two or more components to be analyzed are newly detected during the concentration of a component(s) to be analyzed held in one of the sample holders, to fractionate the newly-detected components to be analyzed using the other sample holders.

The liquid chromatograph according to the present invention further includes a diluent flow path for supplying, between each of the sample holders and the concentrating column, a diluent for promoting the trapping of the component(s) to be analyzed in the concentrating column, wherein the diluent flow path is connected to the concentration flow path. This makes it possible to dilute the component(s) to be analyzed before it (they) is (are) introduced into the concentrating column, thereby enhancing the efficiency of trapping the component(s) to be analyzed in the concentrating column.

The liquid chromatograph according to the present invention includes a primary analysis flow path, at least two sample holders, a concentration flow path, and a secondary analysis flow path, and further includes a first switching system for switching the connections of the sample holders to connect either or any one of the sample holders to the primary analysis flow path and to connect, between the concentration liquid sending unit and the concentrating column provided in the concentration flow path, another sample holder or one of the other sample holders not connected to the primary analysis flow path, and a second switching system for switching the connection of the concentrating column to connect the concentrating column either between the secondary mobile phase sending unit and the secondary analytical column provided in the secondary analysis flow path or to the concentration flow path. Therefore, the liquid chromatograph can simultaneously perform the operation of concentrating component(s) to be analyzed held in one of the sample holders connected between the concentration liquid sending unit and the concentrating column provided in the concentration flow path and the operation of temporarily holding component(s) to be analyzed in another sample holder or one of the other sample holders, which is connected to the primary analysis flow path, for fractionation. Therefore, this eliminates the necessity to interrupt the primary analysis to perform the concentrating operation and the necessity to wait for the completion of the primary analysis before starting the concentrating operation, thereby reducing the total analysis time.

### BRIEF DESCRIPTION OF THE DRAWINGS

FIG. 1 is a flow path diagram schematically showing the structure of a liquid chromatograph according to one embodiment of the present invention.

FIG. 2 is a flow path diagram of the liquid chromatograph shown in FIG. 1 in which a non-fractionation flow path is provided.

FIG. 3 is a flow path diagram of the liquid chromatograph shown in FIG. 1 in which a fractionation flow path is provided.

FIG. 4 is a flow path diagram of the liquid chromatograph shown in FIG. 1 in which a concentration flow path and a non-fractionation flow path are provided.

FIG. 5 is a flow path diagram of the liquid chromatograph shown in FIG. 1 in which a concentration flow path and a fractionation flow path are provided.

FIG. 6 is a flow path diagram of the liquid chromatograph shown in FIG. 1 in which a secondary analysis flow path and a fractionation flow path are provided.

FIG. 7 is a flow path diagram of the liquid chromatograph shown in FIG. 1 in which a secondary analysis flow path and a non-fractionation flow path are provided.

FIG. 8 is a flow path diagram of the liquid chromatograph shown in FIG. 1 in which a concentration flow path and a fractionation flow path are provided.

FIG. 9 is a flow path diagram of the liquid chromatograph shown in FIG. 1 in which a concentration flow path and a non-fractionation flow path are provided.

FIG. 10 is a flow path diagram of the liquid chromatograph shown in FIG. 1 in which a concentration flow path and a fractionation flow path are provided.

### DETAILED DESCRIPTION OF THE INVENTION

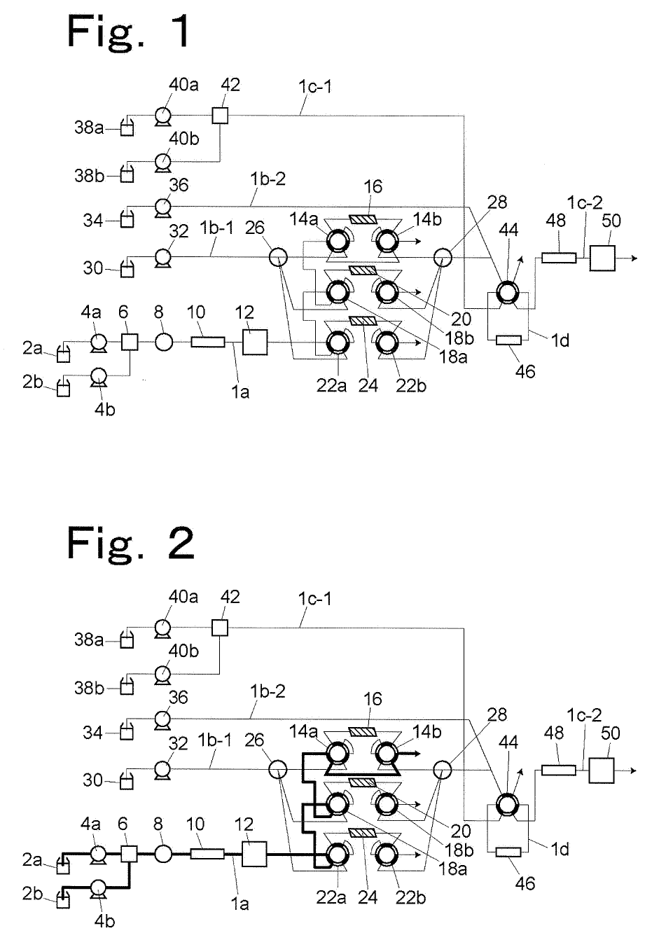

FIG. 1 is a liquid chromatograph according to one embodiment of the present invention. As shown in FIG. 1, the liquid chromatograph includes a primary analysis flow path 1a, three sample loops (sample holders) 16, 20, and 24, a concentration liquidsending flow path 1b-1, a diluent sending flow path 1b-2, a trap column flow path 1d, a secondary mobile phase sending flow path 1c-1, and a concentrated sample analysis flow path 1c-2.

The primary analysis flow path 1a has a primary mobile phase sending system constituted from sending pumps 4a and 4b for sending two kinds of primary mobile phases 2a and 2b and a mixer 6 for mixing these primary mobile phases 2a and 2b, a sample injector 8 provided downstream from the mixer 6 to inject a sample into the flow path 1a, a primary analytical column 10 for separating the injected sample into components, and a detector 12 for detecting the sample components separated by the primary analytical column 10. The sample loops 16, 20, and 24 are each capable of retaining an eluate containing at least one component to be analyzed separated by the primary analysis flow path 1a.

The concentration liquid sending flow path 1b-1 has a pump 32 for sending a liquid 30 for concentration such as water.

The diluent sending flow path 1b-2 has a pump 36 for sending a diluent 34 for diluting an eluate containing component(s) to be analyzed.

The trap column flow path 1d has a trap column 46 that traps component(s) to be analyzed contained in an eluate and allows liquids other than the component(s) to be analyzed to pass through it.

The secondary mobile phase sending flow path 1c-1 has a secondary mobile phase sending system constituted from pumps 40a and 40b for sending two kinds of secondary mobile phases 38a and 38b, respectively, and a mixer 42 for mixing these secondary mobile phases.

The concentrated sample analysis flow path 1c-2 has a secondary analytical column 48 and a secondary detector 50.

A flow path selecting valve 26 is provided to switch the connection of the concentration liquid sending flow path 1b-1 to connect the concentration liquid sending flow path 1b-1 to any one of flow path switching valves 14a, 18a, and 22a. A flow path selecting valve 28 is provided to switch the connection of the flow path switching valve 44 to connect a flow path switching valve 44 to any one of flow path switching valves 14b, 18b, and 22b. The flow path selecting valves 26 and 28 are operated in synchronization with each other. More specifically, when the valve 26 connects the flow path 1b-1 to the valve 14a, the valve 28 connects the valve 14b to the valve 44; when the valve 26 connects the flow path 1b-1 to the valve 18a, the valve 28 connects the valve 18b to the valve 44; and when the valve 26 connects the flow path 1b-1 to the valve 22a, the valve 28 connects the valve 22b to the valve 44.

The flow path switching valve 14a has ports connected to the valve 18a, the valve 14b, one end of the sample loop 16, and the valve 26, respectively. The valve 14a can switch the connection of the valve 18a to connect the valve 18a to either the valve 14b or the one end of the sample loop 16. When the valve 14a is operated to connect the valve 18a to the valve 14b, the one end of the sample loop 16 is connected to the valve 26.

The flow path switching valve 14b has ports connected to the valve 14a, the other end of the sample loop 16, the valve 28, and a drain, respectively. The valve 14b can switch the connection of the other end of the sample loop 16 to connect the other end of the sample loop 16 to either the valve 28 or the drain. When the valve 14b is operated to connect the other end of the sample loop 16 to the valve 28, the valve 14a is connected to the drain.

The flow path switching valve 18a has ports connected to the valve 14a, the valve 22a, one end of the sample loop 20, and the valve 26, respectively. The valve 18a can switch the connection of the valve 22a to connect the valve 22a to either the valve 14a or the one end of the sample loop 20. When the valve 18a is operated to connect the valve 22a to the valve 14a, the one end of the sample loop 20 is connected to the valve 26.

The flow path switching valve 18b has ports connected to the other end of the sample loop 20, the valve 28, and a drain, respectively. The valve 18b can switch the connection of the other end of the sample loop 20 to connect the other end of the sample loop 20 to either the valve 28 or the drain.

The flow path switching valve 22a has ports connected to the primary analysis flow path 1a, the valve 18a, one end of the sample loop 24, and the valve 26, respectively. The valve 22a can switch the connection of the primary analysis flow path 1a to connect the primary analysis flow path 1a to either the valve 18a or the one end of the sample loop 24. When the valve 22a is operated to connect the primary analysis flow path 1a to the valve 18a, the one end of the sample loop 24 is connected to the valve 26.

The flow path switching valve 22b has ports connected to the other end of the sample loop 24, the valve 28, and a drain, respectively. The valve 22b can switch the connection of the other end of the sample loop 24 to connect the other end of the sample loop 24 to either the valve 28 or the drain.

The flow path switching valve 44 has ports connected to the valve 28, the upstream end of the trap column flow path 1d, the downstream end of the trap column flow path 1d, the secondary mobile phase sending flow path 1c-1, the concentrated sample analysis flow path 1c-2, and a drain, respectively. The valve 44 can switch the connection of the upstream end of the trap column flow path 1d to connect the upstream end of the trap column flow path 1d to either the valve 28 or the secondary mobile phase sending flow path 1c-1. When the valve 44 is operated to connect the upstream end of the trap column flow path 1d to the valve 28, the downstream end of the trap column flow path 1d is connected to the drain. On the other hand, when the valve 44 is operated to connect the upstream end of the trap column flow path 1d to the secondary mobile phase sending flow path 1c-1, the downstream end of the trap column flow path 1d is connected to the concentrated sample analysis flow path 1c-2.

The diluent sending flow path 1b-2 is connected to a flow path provided between the flow path selecting valve 28 and the flow path switching valve 44.

The above-described structure of the liquid chromatograph according to this embodiment makes it possible to perform flow path switching using the flow path selecting valves 26 and 28 and the flow path switching valves 14a, 14b, 18a, 18b, 22a, 22b, and 44 to provide a fractionation flow path, a non-fractionation flow path, a concentration flow path, and a secondary analysis flow path. The flow path switching valves 14a, 14b, 18a, 18b, 22a, and 22b constitute a first switching system for switching the connection of the primary analysis flow path 1a to connect the primary analysis flow path 1a to any one of the sample loops 16, 20, and 24 and for switching the connection of the concentration flow path to connect the concentration flow path to any one of the sample loops 16, 20, and 24. The flow path switching valve 44 constitutes a second switching system for switching the connection of the trap column flow path 1d to connect the trap column flow path 1d to either the concentration flow path or the secondary analysis flow path.

Hereinbelow, flow paths provided by flow path switching using the flow path selecting valves 26 and 28 and the flow path switching valves 14a, 14b, 18a, 18b, 22a, 22b, and 44 will be described.

A flow path shown by the thick line in FIG. 2 is a non-fractionation flow path which is provided by operating the flow path switching valves 22a, 18a, 14a, and 14b so that the primary analysis flow path 1a is connected to the drain via the valves 22a, 18a, 14a, and 14b. The non-fractionation flow path makes it possible to discharge a liquid flowing through the primary analysis flow path 1a into the drain without allowing the liquid to pass through any of the sample loops 16, 20, and 24.

A fractionation flow path for holding an eluate in the sample loop 16 is provided by operating the flow path switching valves 22a, 18a, 14a, and 14b so that the primary analysis flow path 1a is connected to the drain via the valves 22a, 18a, and 14a, the sample loop 16, and the valve 14b.

A fractionation flow path for holding an eluate in the sample loop 20 is provided by operating the flow path switching valves 22a, 18a, and 18b so that the primary analysis flow path 1a is connected to the drain via the valves 22a and 18a, the sample loop 20, and the valve 18b.

A fractionation flow path for holding an eluate in the sample loop 24 is provided by operating the flow path switching valves 22a and 22b so that the primary analysis flow path 1a is connected to the drain via the valve 22a, the sample loop 24, and the valve 22b.

A concentration flow path for transporting an eluate retained in the sample loop 16 by a liquid for concentration to the trap column 46 to concentrate component(s) to be analyzed contained in the eluate is provided by connecting the flow path selecting valves 26 and 28 to the flow path switching valves 14a and 14b respectively and operating these valves so that the liquid for concentration flows through the concentration liquid sending flow path 1b-1 into the trap column 46 via the sample loop 16 and the valves 14b, 28, and 44. At this time, the non-fractionation flow path shown in FIG. 2 can also be provided together with the concentration flow path. Alternatively, the fractionation flow path for fractionating an eluate containing component(s) to be analyzed in the sample loop 20 or 24 may be provided together with the concentration flow path by operating the flow path switching valves 18a and 18b or the flow path switching valves 22a and 22b.

Similarly, a concentration flow path for concentrating component(s) to be analyzed retained in the sample loop 20 or 24 can be provided by connecting the flow path selecting valves 26 and 28 to the valves 18a and 18b or the valves 22a and 22b respectively, connecting the concentration liquid sending flow path 1b-1 to the sample loop 20 or 24 via the selected valve 18a or 22a, and operating the selected valve 18b or 22b and the valve 44 so that the sample loop 20 or 24 is connected to the trap column 46 via the valve 44. Also in this case, the non-fractionation flow path or the fractionation flow path using the sample loop other than the sample loop 20 or 24 can be provided together with the concentration flow path.

When the flow path switching valve 44 is operated so that the secondary mobile phase sending flow path 1c-1 is connected to the secondary analytical column 48 via the trap column 46, a secondary analysis flow path for transporting component(s) to be analyzed trapped in the trap column 46 by a secondary mobile phase to the secondary analytical column 48 to analyze the component(s) is provided. At this time, the non-fractionation flow path or the fractionation flow path for holding an eluate containing a component(s) to be analyzed in the sample loop 16, 20, or 24 can be provided together with the secondary analysis flow path.

Hereinbelow, the procedure of analysis using the liquid chromatograph will be described with reference to FIGS. 2 to 10. A sample is injected into the sample injector 8 by, for example, an automatic sampler, and is then carried by a primary mobile phase to the primary analytical column 10 to separate it into components. Each of the separated components to be analyzed is detected by the detector 12. Until the detector 12 detects one component to be analyzed, a non-fractionation flow path is provided as shown by the thick line in FIG. 2 to discharge the primary mobile phase flowing through the primary analysis flow path 1a into the drain.

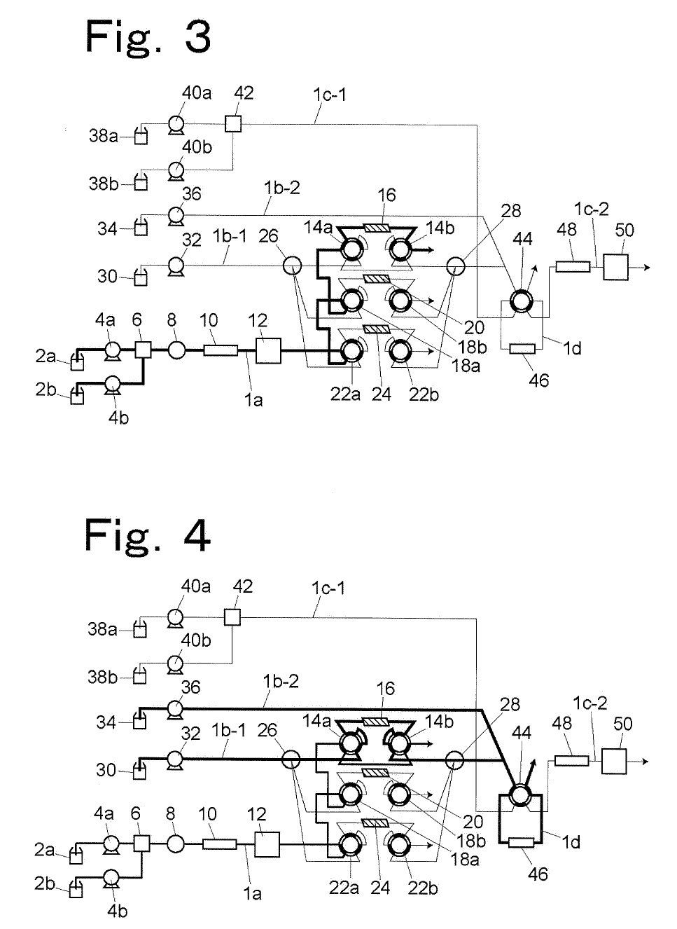

When the detector 12 detects one component to be analyzed, a fractionation flow path is provided as shown by the thick line in FIG. 3 to transport an eluate containing the component to be analyzed detected by the detector 12 to the sample loop 16, and the eluate is retained in the sample loop 16. It is to be noted that in this case, the component to be analyzed initially detected by the detector 12 is retained in the sample loop 16, but may be retained in the sample loop 20 or 24.

After the eluate is retained in the sample loop 16, a concentration flow path is provided as shown by the thickest line in FIG. 4 to transport the eluate containing the component to be analyzed retained in the sample loop 16 to the trap column 46. Then, a liquid for concentration is supplied using the pump 32 to the concentration flow path to introduce the eluate containing the component to be analyzed retained in the sample loop 16 into the trap column 46. At this time, a diluent is supplied using the pump 36 to the concentration flow path through the diluent sending flow path 1b-2 to dilute the eluate containing the component to be analyzed introduced into the trap column 46. This makes it possible to promote the trapping of the component to be analyzed in the trap column 46.

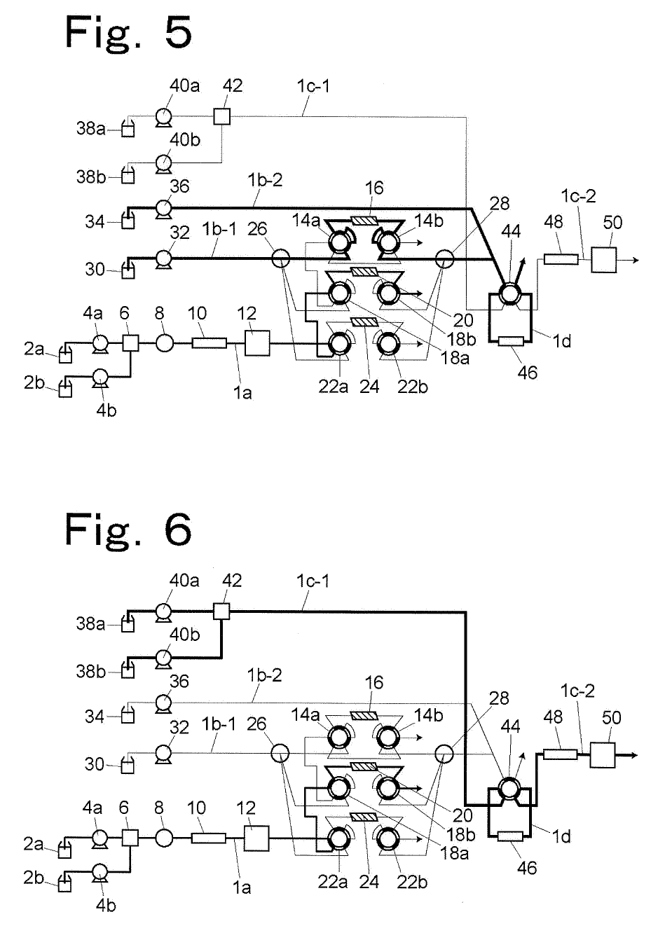

As shown by the thick line thinner than the thickest line in FIG. 4 or 5, a non-fractionation flow path (FIG. 4) or a fractionation flow path (FIG. 5) can be provided together with the concentration flow path during the concentrating operation described above. Therefore, when another component to be analyzed is newly detected by primary analysis performed using the primary analysis flow path la, the newly-detected component to be analyzed can be retained in the sample loop 20 for fractionation. Further, when yet another component to be analyzed is newly detected during the concentrating operation, a fractionation flow path for transporting an eluate containing the newly-detected component to be analyzed to the sample loop 24 is provided as shown by the thick line thinner than the thickest line in FIG. 8 to retain the eluate in the sample loop 24.

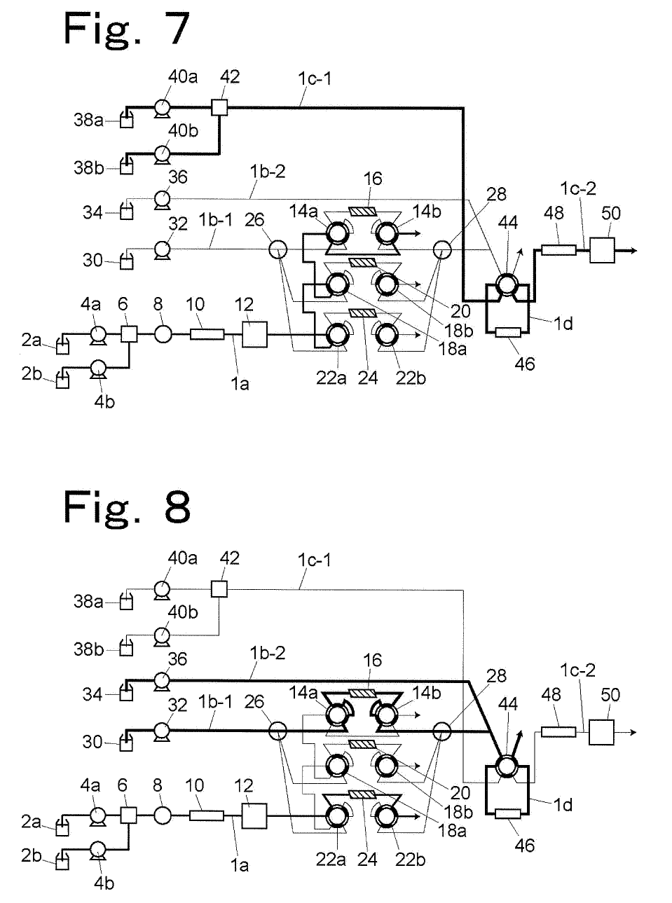

After the completion of the concentration of the component to be analyzed, the pumps 32 and 36 are stopped to stop sending the liquid for concentration and the diluent. Then, as shown by the thickest line in FIG. 6 or 7, a secondary analysis flow path is provided to start secondary analysis. More specifically, a secondary mobile phase is supplied using the pumps 40a and 40b to the secondary analysis flow path to elute the component to be analyzed trapped in the trap column 46 with the secondary mobile phase, and the obtained eluate is introduced into the secondary analytical column 48. The component to be analyzed introduced into the secondary analytical column 48 is further separated and introduced into the secondary detector 50.

Also during the secondary analysis, the primary analysis can be performed using the primary analysis flow path 1a. As shown by the thick line thinner than the thickest line in FIG. 6 or 7, a newly-detected component to be analyzed can be fractionated during the secondary analysis.

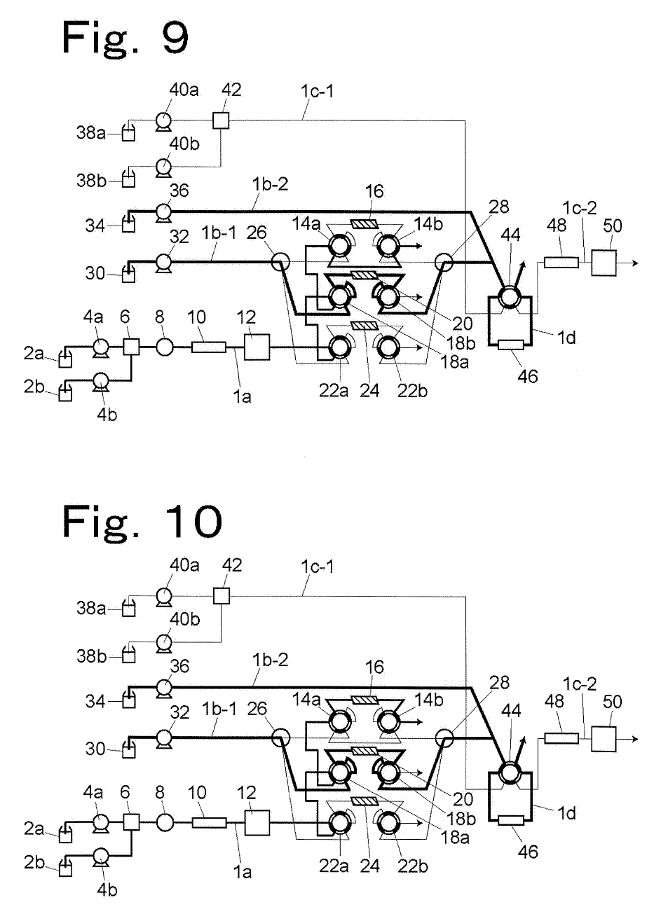

After the completion of the secondary analysis of the component to be analyzed, the pumps 40a and 40b are stopped to stop sending the secondary mobile phase. Then, as shown by the thickest line in FIG. 9 or 10, a concentration flow path for concentrating a component to be analyzed retained in the sample loop other than the sample loop 16 (in this case, the sample loop 20) is provided. Also in this case, as in the case of the concentration of the component to be analyzed retained in the sample loop 16, the primary analysis and the fractionation of newly-detected components to be analyzed can be performed while the concentration of a component to be analyzed retained in the sample loop 20 or 24 is performed. As shown by the thick line thinner than the thickest line in FIG. 10, the empty sample loop 16 is used to retain a newly-detected component to be analyzed.

As has been described above, since the liquid chromatograph according to this embodiment includes a plurality of the sample loops 16, 20, and 24, the concentration and secondary analysis of component(s) to be analyzed retained in one of the sample loops can be performed while the fractionation of newly-detected components to be analyzed is performed using the other sample loops. This makes it possible to reduce the total analysis time.

In the case of using a conventional liquid chromatograph, the concentrating operation cannot be started until the fractionation of all the components to be analyzed is completed. Therefore, there is a case where easily-decomposable components retained in sample loops are decomposed before they are concentrated. However, in the case of using the liquid chromatograph according to this embodiment, it is possible to perform the concentrating operation immediately after one component to be analyzed is retained in one of the sample loops. This makes it possible to reduce the time during which the component to be analyzed is kept retained in the sample loop and therefore to perform the concentration and secondary analysis of the component to be analyzed before the component is decomposed.

It is to be noted that the liquid chromatograph described above has the three sample loops 16, 20, and 24 as sample holders, but the number of the sample loops provided as sample holders may be two or four or more.

What is claimed is:

1. A liquid chromatograph comprising:
a primary analysis flow path having a primary mobile phase sending system for sending a primary mobile phase, a primary analytical column for separating a sample carried by the primary mobile phase into component(s) to be analyzed, and a primary detector for detecting each of the components to be analyzed separated by the primary analytical column;
at least two sample holders each provided downstream from the primary analysis flow path to hold an eluate containing at least one of the components to be analyzed separated by the primary analytical column;
a concentration flow path having a concentration liquid sending unit for sending a liquid for concentration for use in transporting the eluate held in each of the sample holders and a concentrating column for trapping the component(s) to be analyzed contained in the eluate transported by the liquid for concentration;
a secondary analysis flow path having a secondary mobile phase sending unit for sending a secondary mobile phase for use in eluting and transporting the component(s) to be analyzed trapped in the concentrating column, a secondary analytical column for further separating the component(s) to be analyzed transported by the secondary mobile phase, and a secondary detector provided downstream from the secondary analytical column;
a first switching system for switching the connections of the sample holders to connect either or any one of the sample holders to the primary analysis flow path and to connect, between the concentration liquid sending unit and the concentrating column provided in the concentration flow path, another sample holder or one of the other sample holders not connected to the primary analysis flow path; and
a second switching system for switching the connection of the concentrating column to connect the concentrating column either between the secondary mobile phase sending unit and the secondary analytical column provided in the secondary analysis flow path or to the concentration flow path.

2. The liquid chromatograph according to claim 1, wherein the number of the sample holders is three or more, and wherein the first switching system connects each of the sample holders to the primary analysis flow path at different timing.

3. The liquid chromatograph according to claim 2, further comprising a diluent flow path for supplying, between each of the sample holders and the concentrating column, a diluent for promoting the trapping of the component(s) to be analyzed in the concentrating column, wherein the diluent flow path is connected to the concentration flow path.

4. The liquid chromatograph according to claim 1, further comprising a diluent flow path for supplying, between each of the sample holders and the concentrating column, a diluent for promoting the trapping of the component(s) to be analyzed in the concentrating column, wherein the diluent flow path is connected to the concentration flow path.
